(19) United States
(12) Patent Application Publication
(10) Pub. No.: US 2016/0339361 A1
(43) Pub. Date: Nov. 24, 2016

(54) WATER TREATMENT APPARATUS AND WATER TREATMENT METHOD USING THE SAME

(71) Applicant: SUMITOMO ELECTRIC INDUSTRIES, LTD., Osaka-shi, Osaka (JP)

(72) Inventor: Hideki KASHIHARA, Osaka-shi (JP)

(73) Assignee: SUMITOMO ELECTRIC INDUSTRIES, LTD., Osaka-shi, Osaka (JP)

(21) Appl. No.: 14/768,847

(22) PCT Filed: Nov. 12, 2014
(86) PCT No.: PCT/JP2014/079950

§ 371 Date: Aug. 19, 2015

(51) Int. Cl. B01D 24/12; C02F 1/00; B01D 24/00; B01D 15/00; C02F 1/28; B01D 24/46

(52) U.S. Cl. CPC B01D 24/12; C02F 1/28; B01D 24/4636; B01D 24/008; B01D 15/00; C02F 1/004; C02F 2101/32

(57) ABSTRACT

A water treatment apparatus is a water treatment apparatus including a cylindrical main body placed in a substantially perpendicular direction; in order from an upstream side, a first treatment layer containing a plurality of first particles; a first partition plate for preventing falling of the first particles; a second treatment layer containing a plurality of second particles having an average diameter smaller than that of the first particles; and a second partition plate for preventing falling of the second particles, wherein a space portion is provided above the second treatment layer in a steady state. The water treatment apparatus may further include a third treatment layer disposed below the second partition plate and containing an adsorbent that adsorbs an oil. An average diameter of the first particles is preferably 100 μm or larger and 500 μm or smaller.

### TECHNICAL FIELD

The present invention relates to a water treatment apparatus and a water treatment method using the same.

### BACKGROUND ART

From the perspective of environmental conservation, an oil-water mixture liquid including an oil and a suspended substance generated in an oilfield, a factory and the like needs to be discarded after a mixing amount of the oil and the suspended substance is reduced to a certain value or smaller. Examples of a method for separating and removing the oil and the suspended substance from the mixture liquid include gravitational separation, separation by distillation, separation by a chemical agent, and the like. An example of a method for separating and removing the oil and the suspended substance at low cost includes a method for using a treatment tank having a particle contained therein.

A water treatment apparatus using the aforementioned treatment layer separates the oil content and the suspended substance of the oil-water mixture liquid by using the particle in the treatment layer, and discharges the water from which these are removed (refer to Japanese Patent Laying-Open No. 5-154309).

### CITATION LIST

### Patent Document

PTD 1: Japanese Patent Laying-Open No. 5-154309

### SUMMARY OF INVENTION

### Technical Problem

The aforementioned conventional water treatment apparatus can be suitably used for an oil-water mixture liquid in which a size of a particle of an impurity such as oil is within a certain range. However, the number of the treatment layer is one. Therefore, in the case of an oil-water mixture liquid including different-sized suspended substances, an emulsion of oil and the like, treatment must be repeated a plurality of times in a multistage manner, and thus, an increase in size of the apparatus is unavoidable.

The present invention has been made in view of the aforementioned circumstances, and an object of the present invention is to provide a water treatment apparatus and a water treatment method using the same that can efficiently treat a liquid to be treated including oil droplets and suspended substances of various particle diameters in a space-saving manner.

### Solution to Problem

The invention made to solve the aforementioned problem is directed to a water treatment apparatus including a cylindrical main body placed in a substantially perpendicular direction, the water treatment apparatus purifying a liquid to be treated supplied from above through the use of a plurality of treatment layers disposed in the main body, and recovering a treated liquid from below, the water treatment apparatus including:

in order from an upstream side, a first treatment layer containing a plurality of first particles; a first partition plate for preventing falling of the first particles; a second treatment layer containing a plurality of second particles having an average diameter smaller than that of the first particles; and a second partition plate for preventing falling of the second particles, wherein

a space portion is provided above the second treatment layer in a steady state.

Another invention made to solve the aforementioned problem is directed to a water treatment method having a step of supplying a liquid to be treated to the water treatment apparatus, and recovering a treated liquid.

### Advantageous Effects of Invention

The water treatment apparatus according to the present invention can efficiently treat a liquid to be treated including oil droplets and suspended substances of various particle diameters in a space-saving manner. Therefore, the water treatment apparatus and the water treatment method using the same according to the present invention can separate and treat a large amount of an oil-water mixture liquid including an oil and various suspended substances.

### BRIEF DESCRIPTION OF DRAWINGS

FIG. 1 is a schematic end view showing a water treatment apparatus according to one embodiment of the present invention.

FIG. 2 is a schematic end view showing a part of a water treatment apparatus according to an embodiment different from the embodiment of FIG. 1.

FIG. 3 is a schematic end view showing a part of a water treatment apparatus according to an embodiment different from the embodiments of FIGS. 1 and 2.

### DESCRIPTION OF EMBODIMENTS

### Description of Embodiment of the Present Invention

The present invention is directed to a water treatment apparatus including a cylindrical main body placed in a substantially perpendicular direction, the water treatment apparatus purifying a liquid to be treated supplied from above through the use of a plurality of treatment layers disposed in the main body, and recovering a treated liquid from below, the water treatment apparatus including:

in order from an upstream side, a first treatment layer containing a plurality of first particles; a first partition plate for preventing falling of the first particles; a second treatment layer containing a plurality of second particles having an average diameter smaller than that of the first particles; and a second partition plate for preventing falling of the second particles, wherein

a space portion is provided above the second treatment layer in a steady state.

In the water treatment apparatus, the first treatment layer containing the plurality of first particles and the second treatment layer containing the plurality of second particles having the average diameter smaller than that of the first particles are disposed in this order from the upstream side. Therefore, an oil droplet and a suspended substance having a relatively large particle diameter can be separated in the first treatment layer, and thereafter, an emulsified oil droplet and a minute suspended substance can be separated in the second treatment layer. Therefore, the water treatment apparatus can treat the liquid to be treated including the oil and various suspended substances, without combining a plurality of water treatment apparatuses, and thus, the size of the apparatus can be reduced. In addition, in the water treatment apparatus, the space portion is provided above the second treatment layer in the steady state. Therefore, the lifted up and separated oil droplet and suspended substance are retained in this space portion, and thereby, the purification treatment capability can be enhanced. In addition, the oil droplet and the suspended substance retained in the space portion can be easily and reliably discharged outside the main body by backwashing. Furthermore, the second particles contained in the second treatment layer rise into this space portion during backwashing, and thus, the oil droplet, the suspended substance and the like captured between the second particles can also be discharged effectively. As a result, in the water treatment apparatus, the backwashing time and an amount of backwash water can be reduced, and thus, the high water treatment efficiency can be produced.

In addition, the water treatment apparatus has the first partition plate for preventing falling of the first particles. Therefore, it is possible to prevent the first particles from flowing from the first treatment layer to the second treatment layer in the steady state and in the backwash state.

The water treatment apparatus may further include a third treatment layer disposed below the second partition plate and containing an adsorbent that adsorbs an oil. Since the third treatment layer that adsorbs the oil is provided as described above, the minuter oil droplet having passed through the second treatment layer can be further separated, and thus, the purification treatment capability of the water treatment apparatus can be further enhanced. In addition, since it is unnecessary to separately provide a treatment apparatus for oil adsorption in the downstream part of the water treatment apparatus, reduction in size of the water treatment facilities can be promoted.

An average diameter of the first particles is preferably 100 μm or larger and 500 μm or smaller, and an average diameter of the second particles is preferably 10 μm or larger and 200 μm or smaller. Since each of the average diameters of the first particles and the second particles is set to be within the aforementioned range as described above, the oil droplet and the suspended substance having a relatively large particle diameter as well as the oil droplet and the suspended substance having a relatively small particle diameter can be effectively separated in the water treatment apparatus, respectively.

Preferably, an average height of the space portion in the steady state is one time or more of an average thickness of a deposition layer of the plurality of second particles. Since the average height of the space portion in the steady state is set to be equal to or greater than the average thickness of the deposition layer of the second particles as described above, the effect of stirring the second particles during backwashing in the water treatment apparatus can be enhanced, and the effect of discharging the captured oil droplet and suspended substance can be further enhanced.

The water treatment apparatus may further include a backwash water supplying portion for supplying backwash water from below the main body, and a backwash water recovery portion for recovering the backwash water from above the main body. Since the backwash water is supplied from below the main body and is recovered from above the main body as described above, the particles contained in the first treatment layer and the second treatment layer can be stirred, and the oil droplet, the suspended substance and the like can be discharged more effectively. In addition, the first treatment layer and the second treatment layer can be simultaneously backwashed by the aforementioned backwash water supplying portion.

The water treatment apparatus may further include a jet water flow generating portion for injecting the backwash water to the space portion. Since the water treatment apparatus includes the jet water flow generating portion for injecting the backwash water to the space portion as described above, the second particles having risen by the aforementioned backwashing can be stirred more powerfully, and the backwashing effect can be further enhanced.

The first particles and the second particles may be mainly composed of a high-molecular compound. Since the particles mainly composed of the high-molecular compound are used in each treatment layer as described above, the cost and weight of the water treatment apparatus can be reduced. In addition, a specific gravity of the first particles and a specific gravity of the second particles can be reduced, and thus, the stirring effect during backwashing can be further enhanced.

When the water treatment apparatus includes the aforementioned third treatment layer, the adsorbent is preferably non-woven fabric and an average diameter of fibers of the non-woven fabric is preferably 1 μm or smaller. Since the non-woven fabric having the fibers with an average diameter equal to or smaller than the aforementioned lower limit is used as the adsorbent as described above, the oil can be effectively adsorbed. As a result, the treatment capability of the water treatment apparatus can be further enhanced.

Therefore, the water treatment apparatus can be suitably used as an apparatus that obtains, from the liquid to be treated including the oil and the suspended substance, the treated water from which the oil and the suspended substance are separated.

Another present invention is directed to a water treatment method having a step of supplying a liquid to be treated to the water treatment apparatus, and recovering a treated liquid.

In the water treatment method, the liquid to be treated is treated by using the water treatment apparatus. Therefore, the size of the apparatus can be reduced and a space required for water treatment can be reduced. In addition, the high water treatment efficiency caused by the high backwashing efficiency can be obtained.

Preferably, an amount of supply of the liquid to be treated is 100 m³/m²·day or larger. Since the amount of supply of the liquid to be treated is set to be equal to or larger than the aforementioned lower limit, the water treatment method can be suitably used in facilities such as an oilfield that generate a large amount of an oil-water mixture liquid.

### DETAILS OF EMBODIMENT OF THE PRESENT INVENTION

An embodiment of the water treatment apparatus and the water treatment method according to the present invention will be detailed below.

<Water Treatment Apparatus>

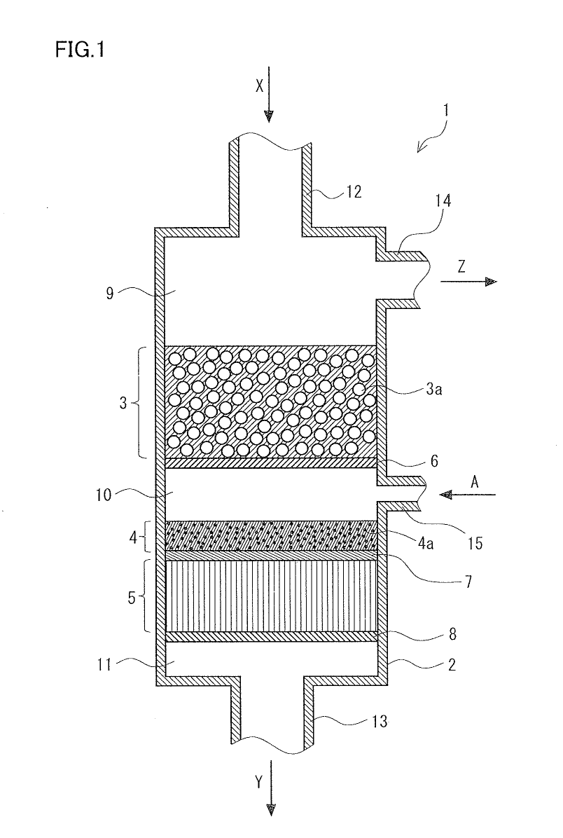

A water treatment apparatus 1 of FIG. 1 includes a cylindrical main body 2 disposed in a substantially perpendicular direction, and a plurality of treatment layers disposed in this main body 2. In order from the upstream side, these plurality of treatment layers are formed of a first treatment layer 3 containing a plurality of first particles 3a, a second treatment layer 4 containing a plurality of second particles 4a having an average diameter smaller than that of first particles 3a, and a third treatment layer 5 containing an adsorbent that adsorbs an oil. Water treatment apparatus 1 also includes a first partition plate 6 disposed between first treatment layer 3 and second treatment layer 4, for preventing falling of first particles 3a, a second partition plate 7 disposed between second treatment layer 4 and third treatment layer 5, for preventing falling of second particles 4a, and a third partition plate 8 disposed on the downstream side of third treatment layer 5, for preventing falling of the adsorbent. Water treatment apparatus 1 further includes a first space portion 9 and a second space portion 10 above first treatment layer 3 and second treatment layer 4 in the steady state, respectively, and includes a header portion 11 below third treatment layer 5. Water treatment apparatus 1 purifies a liquid to be treated X supplied from above through the use of the aforementioned plurality of treatment layers disposed in main body 2, and recovers a treated liquid Y from below.

Moreover, water treatment apparatus 1 further includes a backwash water supplying portion (not shown) for supplying backwash water from below main body 2, a backwash water recovery portion (not shown) for recovering the backwash water from above main body 2, and a jet water flow generating portion (not shown) for injecting the backwash water to aforementioned second space portion 10 from the side.

Water treatment apparatus 1 can be suitably used for a liquid to be treated including an oil and a suspended substance. This suspended substance includes, for example, sand, a particle of silica, calcium carbonate and the like, iron powder, a microorganism, a wood chip, and the like.

(Main Body)

Main body 2 described above is a cylindrical body and is arranged such that a central axis thereof matches substantially with the perpendicular direction. Main body 2 also has: a supply pipe 12 connected to a top surface portion, for supplying liquid to be treated X; a recovery pipe 13 connected to a bottom surface portion, for recovering treated liquid Y; a discharge pipe 14 connected to an upper part of a side surface portion, for discharging backwash water Z during backwashing; and a jet water flow supply pipe 15 connected to a side surface of second space portion 10 described below, for supplying a jet water flow A.

Recovery pipe 13 described above is a pipe connected to the backwash water supplying portion described below, for supplying the backwash water into main body 2 in the backwash state. Discharge pipe 14 described above is a pipe connected to the backwash water recovery portion described below, for discharging the backwash water from inside main body 2. Jet water flow supply pipe 15 described above is a pipe connected to the jet water flow generating portion described below, for supplying jet water flow A into main body 2 in the backwash state. Opening/closing means (not shown) such as a valve is provided at discharge pipe 14 and jet water flow supply pipe 15 in order to prevent an inflow of the water to be treated to the discharge pipe 14 side and the jet water flow supply pipe 15 side in the steady state.

A material of main body 2 is not particularly limited, and metal, synthetic resin and the like can be used. Particularly, from the perspective of strength, heat resistance, chemical resistance and the like, stainless or acrylonitrile-butadiene-styrene copolymer (ABS resin) is preferable.

A planar shape (bottom surface shape) of main body 2 is not particularly limited, and the planar shape of main body 2 can be circular, rectangular and the like. However, a circular shape is preferable. When the planar shape of main body 2 is configured to be circular, any corners in main body 2 can be eliminated, and it is possible to prevent the corner from being clogged with the particle and the like. There is also a merit of facilitating strength design of main body 2.

A size of main body 2 can be appropriately designed in accordance with an amount of treatment of the liquid to be treated. A diameter of main body 2 can be set at, for example, 0.5 m or larger and 5 m or smaller. A height of main body 2 can be set at, for example, 0.5 m or higher and 10 m or lower

(First Treatment Layer)

First treatment layer 3 described above is disposed on the most upstream side in main body 2, and contains the plurality of first particles 3a. Falling of these plurality of first particles 3a is prevented by first partition plate 6 described below, and these plurality of first particles 3a are deposited on the upper surface side of this first partition plate 6 to form a layer. This first treatment layer 3 mainly removes the oil droplet and the suspended substance particle having a relatively large particle diameter which are included in the liquid to be treated.

A known particle for filtration treatment can be used as first particle 3a, and a particle mainly composed of sand, a high-molecular compound, a natural material or the like having a relatively large particle diameter can, for example, be used. Examples of the aforementioned sand can include, for example, anthracite, garnet, manganese sand and the like, and these can be used alone or two or more of these can be used in combination.

Examples of the aforementioned high-molecular compound can include, for example, vinyl resin, polyolefin resin, polyurethane resin, epoxy resin, polyester resin, polyamide resin, polyimide resin, melamine resin, polycarbonate resin and the like. Among these, vinyl resin, polyurethane resin, epoxy resin, and acrylic resin which are excellent in water resistance, oil resistance and the like are preferable, and polyolefin resin which is excellent in absorptivity is more preferable. Furthermore, among polyolefin resin, polypropylene resin which is excellent in oil adsorption capability is particularly preferable. In addition, in the case of the high-molecular compound, it is preferable to use an amorphous pulverized particle. When the amorphous pulverized particle is used, the particles can be deposited in a compact manner, and thus, the filtration efficiency can be enhanced and uplift of the particle in the steady state can be prevented.

A material having a particle size adjusted by sieving can be used as the aforementioned natural material, and examples of the aforementioned natural material can include, for example, a walnut shell, sawdust, a natural fiber such as hemp, and the like.

It is preferable to use the particle mainly composed of the aforementioned high-molecular compound as first particle 3a. When the particle mainly composed of the high-molecular compound is used as first particle 3a as described above, the cost and weight of water treatment apparatus 1 can be reduced. In addition, a specific gravity of first particle 3a can be reduced, and thus, the stirring effect during backwashing can be enhanced.

A lower limit of the average diameter of first particles 3a is preferably 100 μm, more preferably 150 μm, and further preferably 200 μm. If the average diameter of first particles 3a is smaller than the aforementioned lower limit, a density of the particles contained in first treatment layer 3 may become high and a pressure loss of water treatment apparatus 1 may become large, and the cost and weight of water treatment apparatus 1 may increase. On the other hand, an upper limit of the average diameter of first particles 3a is preferably 500 μm, more preferably 400 μm, and further preferably 300 μm. If the average diameter of first particles 3a exceeds the aforementioned upper limit, the capability of removing the oil droplet and the suspended substance particle having a relatively large particle diameter may become insufficient. It is noted that used as the average diameter of the particles is a value obtained by using sieves defined in accordance with JIS-Z8801-1 (2006) to sieve the particles in descending order of mesh size and perform calculation based on the number of particles on the sieve and the mesh size of each sieve.

A lower limit of a uniformity coefficient of first particles 3a is preferably 1.1, and more preferably 1.3. If the uniformity coefficient of first particles 3a is lower than the aforementioned lower limit, variations in particles may become small and there is a possibility that the particles cannot be deposited in a compact manner. On the other hand, an upper limit of the uniformity coefficient of first particles 3a is preferably 1.8, and more preferably 1.6. If the uniformity coefficient of first particles 3a exceeds the aforementioned upper limit, the capability of separating the oil droplet and the suspended substance may become non-uniform in first treatment layer 3. It is noted that used as the uniformity coefficient is a value obtained by D60/D10 when D60 represents a mesh size (particle diameter) of a sieve through which 60 mass % of the particles pass and D10 represents a mesh size (particle diameter) of a sieve through which 10 mass % of the particles pass.

The aforementioned plurality of first particles 3a are deposited on the upper surface of first partition plate 6 described below in the steady state (during treatment of the liquid to be treated). An average thickness of this deposition layer of the plurality of first particles 3a in the steady state is not particularly limited. However, in order to enhance the stirring effect during backwashing, it is preferable that the average thickness is equal to or less than an average height of first space portion 9 described below. The average thickness of the deposition layer of the plurality of first particles 3a in the steady state can be set at, for example, 10 cm or greater and 1 m or less.

(First Partition Plate)

First partition plate 6 described above is a plate disposed between first treatment layer 3 and second treatment layer 4, for preventing falling of first particles 3a. Namely, first partition plate 6 has a configuration that does not allow first particles 3a to pass therethrough and allows the liquid to pass therethrough. Specifically, first partition plate 6 has a mesh (net) structure.

A material of first partition plate 6 is not particularly limited, and metal, synthetic resin and the like can be used. When metal is used, it is preferable to use stainless (particularly, SUS316L) from the perspective of anticorrosion. When synthetic resin is used, it is preferable to use a support member such as a reinforced wire together such that the mesh size does not vary with the water pressure and the weight of the particles.

A nominal mesh size of the mesh of first partition plate 6 is designed to be equal to or smaller than a minimum diameter of the plurality of first particles 3a (maximum mesh size of the sieve through which first particles 3a do not pass). It is preferable to set the nominal mesh size of the mesh of first partition plate 6 to be smaller than a minimum diameter of second particles 4a in order to prevent second particles 4a described below from entering first treatment layer 3 during backwashing. However, when the minimum diameter of second particles 4a is very small, the nominal mesh size of the mesh becomes smaller and a differential pressure becomes large. Therefore, it is preferable to set the nominal mesh size of the mesh of first partition plate 6 to be equal to or smaller than a value obtained by subtracting a standard deviation of the particle diameter of second particles 4a from the average diameter of second particles 4a. An upper limit of this nominal mesh size of the mesh of first partition plate 6 is preferably 100 μm, and more preferably 80 μm or smaller. If the aforementioned nominal mesh size exceeds the aforementioned upper limit, first particles 3a or second particles 4a may pass through first partition plate 6. On the other hand, a lower limit of the aforementioned nominal mesh size is preferably 10 μm, and more preferably 40 μm. If the aforementioned nominal mesh size is smaller than the aforementioned lower limit, the pressure loss of water treatment apparatus 1 may become large.

(First Space Portion)

First space portion 9 described above is a space formed above aforementioned first treatment layer 3 in the steady state and provided between first treatment layer 3 and the top surface of main body 2 described above. A part of the oil and the suspended substance particle separated in first treatment layer 3 stay (are lifted up and separated) in this first space portion 9 and are discharged from discharge pipe 14 described above together with backwash water Z during backwashing. In addition, during backwashing, first particles 3a rise into this first space portion 9 and are stirred, and thereby, first treatment layer 3 can be effectively backwashed. Discharge pipe 14 described above is connected to a side part of this first space portion 9. It is preferable that a portion (opening) of discharge pipe 14 connecting to first space portion 9 is provided with a mesh member and the like having the same level of nominal mesh size as that of first partition plate 6 in order to prevent an inflow of first particles 3a to the discharge pipe 14 side.

The average height of first space portion 9 in the steady state is not particularly limited. However, in order to enhance the stirring effect during backwashing, it is preferable that the average height is equal to or greater than the average thickness of the deposition layer of the aforementioned plurality of first particles 3a. The average height of first space portion 9 in the steady state can be set at, for example, 10 cm or greater and 2 m or less.

A lower limit of a ratio of the average height of first space portion 9 in the steady state to the average thickness of the deposition layer of the aforementioned plurality of first particles 3a is preferably one time, and more preferably twice. If the aforementioned ratio is lower than the aforementioned lower limit, there is a possibility that the effect of backwashing first treatment layer 3 is not sufficiently obtained. On the other hand, an upper limit of the aforementioned ratio is preferably ten times. If the aforementioned ratio exceeds the aforementioned upper limit, the height of water treatment apparatus 1 may become great unnecessarily.

(Second Treatment Layer)

Second treatment layer 4 described above is disposed on the downstream side of first treatment layer 3 described above, and contains the plurality of second particles 4a. Falling of these plurality of second particles 4a is prevented by second partition plate 7 described below, and these plurality of second particles 4a are deposited on the upper surface side of this second partition plate 7 to form a layer. This second treatment layer 4 mainly removes the minute oil droplet and suspended substance included in the liquid to be treated.

A known particle for filtration treatment can be used as second particle 4a, and a particle mainly composed of sand, a high-molecular compound or the like having a relatively small particle diameter can, for example, be used. Examples of the aforementioned sand can include, for example, diatomite and the like. Examples of the aforementioned high-molecular compound can include, for example, vinyl resin, polyolefin resin, polyurethane resin, epoxy resin, polyester resin, polyamide resin, polyimide resin, melamine resin, polycarbonate resin and the like. Among these, vinyl resin, polyurethane resin, epoxy resin, and acrylic resin which are excellent in water resistance, oil resistance and the like are preferable, and polyolefin resin which is excellent in absorptivity is more preferable. Furthermore, among polyolefin resin, polypropylene resin which is excellent in oil adsorption capability is particularly preferable. In addition, in the case of the high-molecular compound, it is preferable to use an amorphous pulverized particle. When the amorphous pulverized particle is used, the particles can be deposited in a compact manner, and thus, the filtration efficiency can be enhanced and uplift of the particle in the steady state can be prevented.

It is preferable to use the particle mainly composed of the aforementioned high-molecular compound as second particle 4a. When the particle mainly composed of the high-molecular compound is used as second particle 4a as described above, the cost and weight of water treatment apparatus 1 can be reduced. In addition, a specific gravity of second particle 4a can be reduced, and thus, the stirring effect during backwashing can be enhanced.

An average diameter of second particles 4a is smaller than the average diameter of first particles 3a described above. A lower limit of the average diameter of second particles 4a is preferably 10 μm, more preferably 20 μm, and further preferably 30 μm. If the average diameter of second particles 4a is smaller than the aforementioned lower limit, a density of the particles contained in second treatment layer 4 may become high and the pressure loss of water treatment apparatus 1 may become large, and the cost and weight may increase. On the other hand, an upper limit of the average diameter of second particles 4a is preferably 200 μm, more preferably 150 μm, and further preferably 100 μm. If the average diameter of second particles 4a exceeds the aforementioned upper limit, the capability of removing the minute oil droplet and suspended substance may become insufficient. A uniformity coefficient of second particles 4a can be similar to that of first particles 3a described above.

The aforementioned plurality of second particles 4a are deposited on the upper surface of second partition plate 7 described below in the steady state (during treatment of the liquid to be treated). An average thickness of this deposition layer of the plurality of second particles 4a in the steady state is not particularly limited. However, in order to enhance the stirring effect during backwashing, it is preferable that the average thickness is equal to or less than an average height of second space portion 10 described below. The average thickness of the deposition layer of the plurality of second particles 4a in the steady state can be set at, for example, 1 cm or greater and 50 cm or less.

(Second Partition Plate)

Second partition plate 7 described above is a plate disposed between second treatment layer 4 and third treatment layer 5, for preventing falling of second particles 4a. Namely, similarly to first partition plate 6 described above, second partition plate 7 has a configuration that does not allow second particles 4a to pass therethrough and allows the liquid to pass therethrough, and specifically has a mesh (net) structure.

A material of second partition plate 7 can be similar to that of first partition plate 6 described above.

It is preferable to design a nominal mesh size of the mesh of second partition plate 7 to be equal to or smaller than a minimum diameter of the plurality of second particles 4a (maximum mesh size of the sieve through which second particles 4a do not pass). However, when the minimum diameter of second particles 4a is very small, the nominal mesh size of the mesh becomes smaller and the differential pressure becomes large. Therefore, the nominal mesh size of the mesh of second partition plate 7 is set to be equal to or smaller than a value obtained by subtracting a standard deviation of the particle diameter of second particles 4a from the average diameter of second particles 4a. An upper limit of this nominal mesh size of the mesh of second partition plate 7 is preferably 80 μm, and more preferably 50 μm or smaller. If the aforementioned nominal mesh size exceeds the aforementioned upper limit, second particles 4a may pass through second partition plate 7. On the other hand, a lower limit of the aforementioned nominal mesh size is preferably 10 μm, and more preferably 20 μm. If the aforementioned nominal mesh size is smaller than the aforementioned lower limit, the pressure loss of water treatment apparatus 1 may become large.

(Second Space Portion)

Second space portion 10 described above is a space formed above aforementioned second treatment layer 4 in the steady state and provided between second treatment layer 4 and first partition plate 6 described above. A part of the oil and the suspended substance particle separated in second treatment layer 4 stay (are lifted up and separated) in this second space portion 10, and pass through first treatment layer 3 in the direction opposite to the direction in the steady state and are discharged from discharge pipe 14 described above via first space portion 9 described above together with backwash water Z during backwashing. In addition, during backwashing, second particles 4a rise into this second space portion 10 and are stirred, and thereby, second treatment layer 4 can be effectively backwashed. This second space portion 10 also has the effect of enhancing the removal effect during backwashing due to the growth of the staying particles such as the oil droplet and the increase in particle diameter thereof. Jet water flow supply pipe 15 described above is connected to a side part of this second space portion 10. It is preferable that a portion (opening) of jet water flow supply pipe 15 connecting to second space portion 10 is provided with a mesh member and the like having the same level of nominal mesh size as that of second partition plate 7 in order to prevent an inflow of second particles 4a to the jet water flow supply pipe 15 side.

The average height of second space portion 10 in the steady state is not particularly limited. However, in order to enhance the stirring effect during backwashing, it is preferable that the average height is equal to or greater than the average thickness of the deposition layer of the aforementioned plurality of second particles 4a. The average height of second space portion 10 in the steady state can be set at, for example, 2 cm or greater and 1 m or less.

A lower limit of a ratio of the average height of second space portion 10 in the steady state to the average thickness of the deposition layer of the aforementioned plurality of second particles 4a is preferably one time, and more preferably twice. If the aforementioned ratio is lower than the aforementioned lower limit, there is a possibility that the effect of backwashing second treatment layer 4 is not sufficiently obtained. On the other hand, an upper limit of the aforementioned ratio is preferably ten times. If the aforementioned ratio exceeds the aforementioned upper limit, the height of water treatment apparatus 1 may become great unnecessarily.

An upper limit of a distance from a surface of the deposition layer of the aforementioned plurality of second particles 4a to a center of the opening of jet water flow supply pipe 15 in main body 2 is preferably 0.8 times, and more preferably 0.6 times as great as the average height of second space portion 10 in the steady state. On the other hand, a lower limit of the aforementioned distance is preferably 0.2 times, and more preferably 0.3 times as great as the aforementioned average height of second space portion 10. When the aforementioned distance is set to be within the aforementioned range, the effect of stirring second particles 4a by jet water flow A can be significantly enhanced.

(Third Treatment Layer)

Third treatment layer 5 described above is disposed on the downstream side of second treatment layer 4 described above, and contains the adsorbent that adsorbs the oil. Falling of this adsorbent is prevented by third partition plate 8 described below, and this adsorbent is filled into a space between this third partition plate 8 and second partition plate 7 described above to form a layer. This third treatment layer 5 mainly adsorbs and removes the minuter oil droplet that could not be removed in first treatment layer 3 and second treatment layer 4.

A known adsorbent for oil can be used as the aforementioned adsorbent, and examples of the adsorbent can include, for example, porous ceramics, non-woven fabric, woven fabric, fiber, activated carbon and the like. Among these, non-woven fabric formed by a plurality of organic fibers is preferable. This non-woven fabric formed by the plurality of organic fibers adsorbs the oil content by the organic fibers, and thereby, performs oil-water separation. Therefore, in this non-woven fabric, a pore diameter can be increased without the need to make minuter a pore formed between the fibers, and thus, clogging of the pore with the high-viscosity oil can be suppressed and an increase in pressure loss can be suppressed.

A main component of the organic fibers that form the aforementioned non-woven fabric is not particularly limited as long as the main component is organic resin that can adsorb the oil, and examples of the organic resin can include, for example, cellulose resin, rayon resin, polyester resin, polyurethane resin, polyolefin resin (such as polyethylene resin and polypropylene resin), polyamide resin (such as aliphatic polyamide resin and aromatic polyamide resin), acrylic resin, polyacrylonitrile resin, polyvinyl alcohol resin, polyimide resin, silicone resin, fluororesin and the like.

Among these, fluororesin or polyolefin resin is preferable. When the organic fibers mainly composed of fluororesin are used, the heat resistance and the chemical resistance of the non-woven fabric can be enhanced. Furthermore, among fluororesin, polytetrafluoroethylene resin which is excellent in heat resistance and the like is particularly preferable. In addition, when the organic fibers mainly composed of polyolefin resin are used, the oil adsorption capability of the non-woven fabric can be enhanced. Furthermore, among polyolefin resin, polypropylene resin which is excellent in oil adsorption capability is particularly preferable. Other polymers, an additive such as a lubricant, and the like may be blended as appropriate into the material for the organic fibers.

An upper limit of an average diameter of the aforementioned organic fibers is preferably 1 μm, more preferably 0.9 μm, and further preferably 0.1 μm. If the average diameter of the organic fibers exceeds the aforementioned upper limit, a surface area per unit volume of the organic fibers decreases, and thus, a fiber density must be increased in order to ensure a certain level of the oil adsorption capability. As a result, the pore diameter and a porosity of the non-woven fabric decrease and clogging with the oil becomes more likely to occur. Particularly when liquid to be treated X includes a fuel oil C, a particle diameter of the fuel oil C diffused and included in the water is likely to be approximately 0.1 to 1.0 μm. Therefore, when the average diameter of the organic fibers is set to be equal to or smaller than the aforementioned upper limit, the fuel oil C can be adsorbed more reliably. On the other hand, a lower limit of the average diameter of the organic fibers is preferably 10 nm. If the average diameter of the organic fibers is smaller than the aforementioned lower limit, formation of the non-woven fabric may become difficult and the strength may become insufficient.

A lower limit of the porosity of the aforementioned non-woven fabric is preferably 80%, more preferably 85%, and further preferably 88%. If the porosity of the non-woven fabric is lower than the aforementioned lower limit, an amount of passage of the liquid to be treated through the non-woven fabric (amount of treatment) may decrease and the pore of the non-woven fabric may become more likely to be clogged with the oil content. On the other hand, an upper limit of the porosity of the non-woven fabric is preferably 99%, and more preferably 95%. If the porosity of the non-woven fabric exceeds the aforementioned upper limit, there is a possibility that the strength of the non-woven fabric cannot be maintained.

A lower limit of an average pore diameter of the aforementioned non-woven fabric is preferably 1 μm, more preferably 2 μm, and further preferably 5 μm. If the average pore diameter of the non-woven fabric is smaller than the aforementioned lower limit, the amount of passage of the liquid to be treated through the non-woven fabric (amount of treatment) may decrease and the pore of the non-woven fabric may become more likely to be clogged with the oil content. On the other hand, an upper limit of the average pore diameter of the non-woven fabric is preferably 20 μm, and more preferably 8 μm. If the average pore diameter of the non-woven fabric exceeds the aforementioned upper limit, the oil adsorption capability of the non-woven fabric may decrease and there is a possibility that the strength of the non-woven fabric cannot be maintained.

A method for manufacturing the aforementioned non-woven fabric is not particularly limited, and a known method for manufacturing the non-woven fabric can be used. Specific examples of the method for manufacturing the non-woven fabric can include, for example, a method for using a spun lace method, a thermal bond method, a needle punch method, a chemical bond method, a stitch bond method, a needle punch method, an air through method, a point bond method and the like to bond a fleece manufactured by a dry method, a wet method, a spunbond method, a melt blowing method and the like. Or specific examples can include a method for using melt blowing to inject an adhesive fiber body at high speed and thereby form a web. Among these bonding methods, the method for using melt blowing to form the web is preferable, which allows relatively easy formation of the non-woven fabric having a small fiber diameter.

Third treatment layer 5 can also be formed by filling a plurality of fibers into main body 2. It is preferable to use a long fiber having an average diameter of 1 μm or smaller as this fiber.

An average thickness of third treatment layer 5 can be appropriately designed depending on the type of the adsorbent, and can be set at, for example, 1 cm or greater and 1 mm or less.

(Third Partition Plate)

Third partition plate 8 described above is a plate disposed on the downstream side of third treatment layer 5, for preventing falling of the adsorbent. Namely, third partition plate 8 has a configuration that does not allow the adsorbent to pass therethrough and allows the liquid to pass therethrough, and specifically has a mesh (net) structure.

A material of third partition plate 8 can be similar to that of first partition plate 6 described above. In addition, a nominal mesh size of the mesh of third partition plate 8 may only be a size that can prevent falling (outflow) of the adsorbent, and can be appropriately designed depending on the type of the adsorbent.

(Header Portion)

Header portion 11 described above is a space formed below third treatment layer 5 described above, i.e., formed between third partition plate 8 and a bottom surface of main body 2 described above. Recovery pipe 13 for recovering treated liquid Y is connected to a lower part of this header portion 11, and treated liquid Y having passed through first treatment layer 3, second treatment layer 4 and third treatment layer 5 is collected in this header portion 11 and then is recovered.

(Backwash Water Supplying Portion)

The aforementioned backwash water supplying portion (not shown) supplies the backwash water from the lower part to the upper part of water treatment apparatus 1 through recovery pipe 13 described above.

The backwash water supplying portion supplies the backwash water by, for example, pressure-feeding the treated liquid by a pump. Due to an upward flow of this backwash water, the plurality of first particles 3a and second particles 4a rise up and are stirred, and thereby, the oil droplet, the suspended substance and the like captured between the particles are separated and these flow to the upper part of water treatment apparatus 1. The oil droplet and the suspended substance having flowed to the upper part are recovered in the below-described backwash water recovery portion through discharge pipe 14 together with backwash water Z.

(Jet Water Flow Generating Portion)

The aforementioned jet water flow generating portion injects jet water flow A (backwash water) toward second space portion 10 through jet water flow supply pipe 15 described above.

The jet water flow generating portion injects jet water flow A toward second space portion 10. A bubbling jet device, an eductor and the like can, for example, be used as this jet water flow generating portion.

The aforementioned bubbling jet device is a device in which a bubbling jet nozzle is disposed at jet water flow supply pipe 15 described above and the gas and the backwash water are supplied to this bubbling jet nozzle to inject the jet water. As the aforementioned gas, the air can, for example, be used and the drawn-in outside air of water treatment apparatus 1 can be used. In addition, it is preferable to set a volume ratio of the gas to the backwash water in the jet water to be high, and the ratio of the gas volume to the backwash water volume is, for example, preferably twice or higher and five times or lower. In addition, an average diameter of a bubble formed by this gas is preferably 1 mm or larger and 4 mm or smaller. Furthermore, a water feeding pressure of the backwash water is preferably 0.2 MPa or higher, and a flux of the jet water at a discharge port of the bubbling jet nozzle is preferably 20 m/d or greater.

The aforementioned eductor is a device for drawing in the surrounding water and generating a strong water flow. It is possible to, for example, use a device including a suction port at a throat portion between a nozzle for discharging the jet water and a pipe for supplying a fluid (backwash water) to this nozzle, in which the fluid is further drawn in from the aforementioned suction port by a flow of the fluid passing through this throat portion, and thereby, the jet water is injected from the aforementioned nozzle.

Jet water flow A generated by the jet water flow generating portion is injected from the side, from jet water flow supply pipe 15 into second space portion 10. Due to jet water flow A from the side, in addition to the upward flow caused by the backwash water supplied from the aforementioned backwash water supplying portion, second particles 4a are stirred more greatly, and the captured oil droplet, suspended substance and the like can be separated and removed more reliably.

An amount of flow of the backwash water (a total amount of flow in the backwash water supplying portion and the jet water flow generating portion) can be set to be, for example, twice as large as an amount of supply of the liquid to be treated during filtration. A backwashing time can be set at, for example, 30 seconds or longer and 10 minutes or shorter, and a backwashing interval can be set at, for example, 1 hour or longer and 12 hours or shorter.

(Backwash Water Recovery Portion)

The aforementioned backwash water recovery portion (not shown) recovers backwash water Z including the oil droplet and the suspended substance through discharge pipe 14. This recovered backwash water can, for example, be supplied again to water treatment apparatus 1 as liquid to be treated X.

(Advantage)

In water treatment apparatus 1, the oil droplet and the suspended substance having a relatively large particle diameter can be separated in first treatment layer 3, and thereafter, the emulsified oil droplet and the minute suspended substance can be separated in second treatment layer 4. Therefore, water treatment apparatus 1 can treat the liquid to be treated including the oil and various suspended substances, without combining a plurality of water treatment apparatuses, and thus, the size of the apparatus can be reduced. In addition, water treatment apparatus 1 includes first space portion 9 and second space portion 10 above first treatment layer 3 and second treatment layer 4 in the steady state, respectively. Therefore, the lifted up and separated oil droplet and suspended substance are retained in these space portions, and thereby, the purification treatment capability can be enhanced. In addition, the oil droplet and the suspended substance retained in the space portions can be easily and reliably discharged outside main body 2 by backwashing. Furthermore, the particles contained in first treatment layer 3 and second treatment layer 4 rise into these space portions during backwashing, and thus, the particles and the like such as the oil droplet and the suspended substance captured between the particles can be effectively discharged. As a result, in water treatment apparatus 1, the backwashing time and the amount of the backwash water can be reduced, and thus, the high water treatment efficiency can be produced.

In addition, water treatment apparatus 1 has first partition plate 6 and second partition plate 7 for preventing falling of first particles 3a and second particles 4a. Therefore, it is possible to prevent first particles 3a and second particles 4a from flowing to the other treatment layers in the steady state and in the backwash state.

Furthermore, water treatment apparatus 1 includes third treatment layer 5 containing the adsorbent that adsorbs the oil. Therefore, the minuter oil droplet having passed through second treatment layer 4 can be further separated and a high oil separation capability is achieved. In addition, since it is unnecessary to separately provide a treatment apparatus for oil adsorption in the downstream part of water treatment apparatus 1, reduction in size of the water treatment facilities can be promoted.

In addition, water treatment apparatus 1 includes the backwash water supplying portion and the jet water flow generating portion for supplying the backwash water from below and the side of main body 2 described above, and the backwash water recovery portion for recovering the backwash water from above main body 2. Therefore, the particles contained in first treatment layer 3 and second treatment layer 4 can be stirred, and the oil droplet, the suspended substance and the like can be effectively discharged. In addition, first treatment layer 3 and second treatment layer 4 can be simultaneously backwashed by the aforementioned backwash water supplying portion.

<Water Treatment Method>

The water treatment method has a step of supplying the liquid to be treated to the water treatment apparatus and recovering the treated liquid.

A method for supplying the liquid to be treated is not particularly limited, and a method for pressure-feeding the liquid to be treated to the water treatment apparatus by using a pump or water head can, for example, be used.

A lower limit of the amount of supply of the liquid to be treated in the water treatment method is preferably 100 m³/m²·day, more preferably 200 m³/m²·day, and further preferably 300 m³/m²·day. When the oil content concentration, the suspended substance concentration and the viscosity of the liquid to be treated are high, a high water quality can be obtained and sufficiently inexpensive treatment can be performed even at a treatment speed lower than the aforementioned lower limit. However, when the concentration of the liquid to be treated is low and high-speed treatment is desired from a cost perspective, the water treatment method may become unsuitable for use under the environment in which a large amount of the liquid to be treated is generated, if the amount of supply of the liquid to be treated is smaller than the aforementioned lower limit. An upper limit of the amount of supply of the liquid to be treated is not particularly limited, and can be set at, for example, 1000 m³/m²·day.

An upper limit of a suspended substance concentration of the treated liquid recovered in accordance with the water treatment method is preferably 10 ppm, more preferably 5 ppm, further preferably 3 ppm, and particularly preferably 1 ppm or lower. When the suspended substance concentration of the treated liquid is set to be equal to or lower than the aforementioned upper limit, the treated liquid treated in accordance with the water treatment method can be discarded without applying any load to the environment and can be used as the industrial water. It is noted that the suspended substance concentration refers to a concentration of a floating substance (SS) and a value measured in conformity with “14.1 Suspended Matter” in JIS-K0102 (2008) is used.

An upper limit of an oil concentration of the treated liquid recovered in accordance with the water treatment method is preferably 100 ppm, more preferably 50 ppm, further preferably 10 ppm, and particularly preferably 1 ppm or lower. When the oil concentration of the treated liquid is set to be equal to or lower than the aforementioned upper limit, the load of the oil-water separation treatment performed after the water treatment method can be reduced. Depending on the conditions, the treated liquid that was oil-water separated in accordance with the water treatment method can be discarded without applying any load to the environment, even if the other oil-water separation treatment is not performed.

(Advantage)

The water treatment method is excellent in capability of purifying the liquid to be treated including the oil and the suspended substance, and can efficiently treat the liquid to be treated in a space-saving manner.

### Other Embodiments

It should be understood that the embodiment disclosed herein is illustrative and not limitative in any respect. The scope of the present invention is not limited to the configuration of the aforementioned embodiment, is defined by the terms of the claims, and is intended to include any modifications within the scope and meaning equivalent to the terms of the claims.

The water treatment apparatus according to the aforementioned embodiment includes the third treatment layer on the downstream side of the second treatment layer. However, when an amount of oil included in the liquid to be treated is small, the third treatment layer can be omitted. In addition, in the case of providing the third treatment layer, the third partition plate and the bottom surface of the main body may abut each other without providing the header portion. In this case, the third partition plate may be provided only at the opening of the recovery pipe.

In addition, in the water treatment apparatus, the first space portion formed above the first treatment layer in the steady state is not an essential component and can be omitted. However, in order to make effective the backwashing effect and the recovery of the backwash water in the first treatment layer, it is preferable to provide the first space portion.

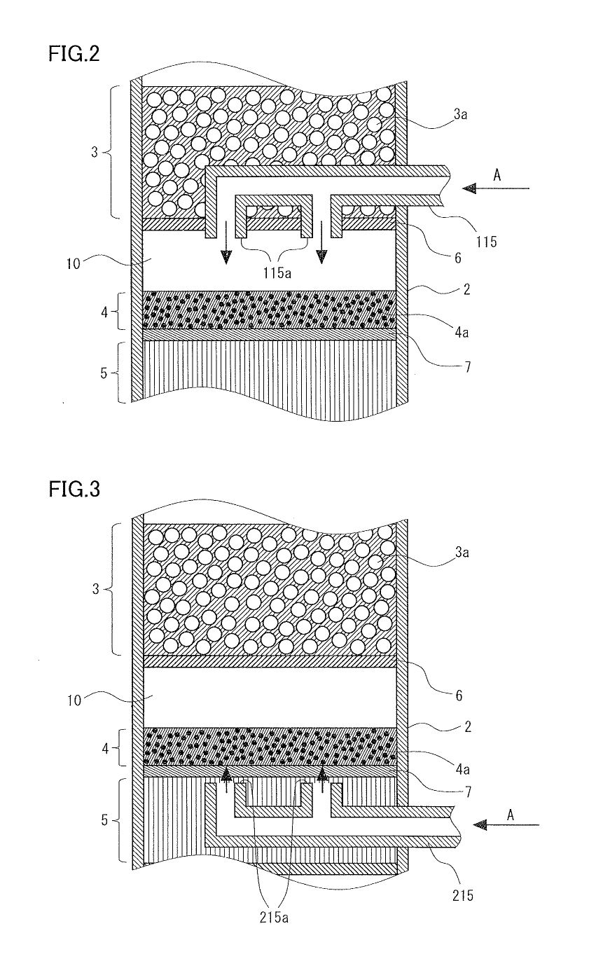

Furthermore, like a jet water flow supply pipe 115 shown in FIG. 2, the jet water flow supply pipe of the water treatment apparatus may be formed to inject jet water flow A from an upper part to a lower part of second space portion 10. Specific description will follow. Jet water flow supply pipe 115 is inserted into first treatment layer 3 and has a plurality of openings (nozzles) 115a formed in second space portion 10. This opening 115a is formed to face downwardly in second space portion 10. According to such jet water flow supply pipe 115, due to an upward flow of the backwash water supplied from below and a downward flow of jet water flow A injected from this jet water flow supply pipe 115, second particles 4a can be stirred more powerfully, and the oil droplet, the suspended substance and the like can be separated more reliably. It is preferable that opening 115a described above is provided with a mesh member and the like having the same level of nominal mesh size as that of second partition plate 7 in order to prevent an inflow of second particles 4a to the jet water flow supply pipe 115 side.

Moreover, like a jet water flow supply pipe 215 shown in FIG. 3, the jet water flow supply pipe of the water treatment apparatus may be formed to inject jet water flow A from third treatment layer 5 to second space portion 10 located above (the second treatment layer 4 side). Specific description will follow. Jet water flow supply pipe 215 is inserted into third treatment layer 5 and has a plurality of openings (nozzles) 215a formed in third treatment layer 5. This opening 215a is formed to face upwardly in third treatment layer 5. According to such jet water flow supply pipe 215, due to a jet flow of jet water flow A injected from this jet water flow supply pipe 215, in addition to the backwash water supplied from the backwash water supplying portion through recovery pipe 13, second particles 4a and first particles 3a can be stirred more powerfully, and the oil droplet, the suspended substance and the like can be separated more reliably. This jet water flow supply pipe 215 may be disposed in header portion 11. A portion (upwardly extending portion) of aforementioned jet water flow supply pipe 215 having opening 215a may pass through second partition plate 7, and opening 215a described above may be formed in second treatment layer 4 or may be integrated with second partition plate 7. In this case, it is preferable that opening 215a is provided with a mesh member and the like having the same level of nominal mesh size as that of second partition plate 7 in order to prevent an inflow of second particles 4a to the jet water flow supply pipe 215 side.

The jet water flow supply pipe of the water treatment apparatus can be omitted. Conversely, the first space portion of the water treatment apparatus may further be provided with a jet water flow generating portion for stirring the first particles.

### INDUSTRIAL APPLICABILITY

As described above, the water treatment apparatus according to the present invention can efficiently treat a liquid to be treated including oil droplets and suspended substances of various particle diameters in a space-saving manner. Therefore, the water treatment apparatus and the water treatment method using the same according to the present invention can efficiently separate and treat the liquid to be treated including the oil and the suspended substances, and thus, can be suitably used in production facilities such as a factory and an oilfield.

### REFERENCE SIGNS LIST

1 water treatment apparatus; 2 main body; 3 first treatment layer; 3a first particle; 4 second treatment layer; 4a second particle; 5 third treatment layer; 6 first partition plate; 7 second partition plate; 8 third partition plate; 9 first space portion; 10 second space portion; 11 header portion; 12 supply pipe; 13 recovery pipe; 14 discharge pipe; 15, 115, 215 jet water flow supply pipe; 115a, 215a opening.

1: A water treatment apparatus including a cylindrical main body placed in a substantially perpendicular direction, the water treatment apparatus purifying a liquid to be treated supplied from above through the use of a plurality of treatment layers disposed in said main body, and recovering a treated liquid from below, the water treatment apparatus comprising:
in order from an upstream side, a first treatment layer containing a plurality of first particles; a first partition plate for preventing falling of said first particles; a second treatment layer containing a plurality of second particles having an average diameter smaller than that of said first particles; and a second partition plate for preventing falling of said second particles, wherein
a space portion is provided above said second treatment layer in a steady state.

2: The water treatment apparatus according to claim 1, further comprising
a third treatment layer disposed below said second partition plate and containing an adsorbent that adsorbs an oil.

3: The water treatment apparatus according to claim 1, wherein
an average diameter of said first particles is 100 μm or larger and 500 μm or smaller, and an average diameter of said second particles is 10 μm or larger and 200 μm or smaller.

4: The water treatment apparatus according to claim 1, wherein
an average height of said space portion in the steady state is one time or more of an average thickness of a deposition layer of said plurality of second particles.

5: The water treatment apparatus according to claim 1, further comprising
a backwash water supplying portion for supplying backwash water from below said main body, and a backwash water recovery portion for recovering said backwash water from above said main body.

6: The water treatment apparatus according to claim 5, further comprising
a jet water flow generating portion for injecting said backwash water to said space portion.

7: The water treatment apparatus according to claim 1, wherein
said first particles and said second particles are mainly composed of a high-molecular compound.

8: The water treatment apparatus according to claim 2, wherein
said adsorbent is non-woven fabric and an average diameter of fibers of said non-woven fabric is 1 μm or smaller.

9: The water treatment apparatus according to claim 1, wherein
said liquid to be treated includes an oil and a suspended substance, and said oil and said suspended substance are separated from said liquid to be treated.

10: A water treatment method comprising a step of supplying a liquid to be treated to the water treatment apparatus as recited in claim 1, and recovering a treated liquid.

11: The water treatment method according to claim 10, wherein
an amount of supply of said liquid to be treated is 100 m³/m²·day or larger.
